(19) United States
(12) Patent Application Publication
(10) Pub. No.: US 2025/0026876 A1
(43) Pub. Date: Jan. 23, 2025

(54) CATIONIC EMULSION TERPOLYMER FOR INCREASING CAKE SOLIDS

(71) Applicant: SOLENIS TECHNOLOGIES, L.P., Wilmington, DE (US)

(72) Inventors: Nathalie Bruzzano, Duisburg (DE); Markus Bröcher, Mülheim an der Ruhr (DE)

(73) Assignee: SOLENIS TECHNOLOGIES, L.P., Wilmington, DE (US)

(21) Appl. No.: 18/770,693

(22) Filed: Jul. 12, 2024

Related U.S. Application Data
(60) Provisional application No. 63/514,578, filed on Jul. 20, 2023.

(51) Int. Cl. C08F 220/56; C02F 11/122; C02F 103/10; C02F 103/28

(52) U.S. Cl. CPC C08F 220/56; C02F 11/122; C02F 2103/10; C02F 2103/28

(57) ABSTRACT

The present disclosure generally relates to dewatering aqueous sludge that is produced by waste water or sewage treatment facilities such as from municipal and industrial processes. The method includes treating an aqueous sludge with a cationic polyacrylamide polymer comprising the reaction product of: acrylyl monomer(s) comprising a nonionic amide; cationic monomer(s); and vinyl monomer(s).

### CROSS REFERENCE TO RELATED APPLICATIONS

This application claims the benefit of U.S. Provisional application No. 63/514,578, filed 20 Jul. 2023, the entire contents of which are hereby incorporated by reference.

### TECHNICAL FIELD

The present disclosure generally relates to a composition and method of dewatering aqueous sludge that is produced by waste water or sewage treatment facilities such as from municipal and industrial processes. The method includes treating an aqueous sludge with a cationic polyacrylamide polymer that includes acrylic monomer(s); cationic monomer(s); and vinyl monomer(s) comprising a second nonionic group different from the nonionic amide groups, and dewatering the treated aqueous sludge.

### BACKGROUND

The effluent streams coming from the processes mentioned above generally contain waste solids that cannot be directly recycled and are conveyed by a sewerage system to a waste water treatment plant facility. The effluent stream goes through a series of operations depending on the particular industry and set-up of the waste water treatment facility, to concentrate and dewater the waste solids thereby producing a sludge. Ultimately, the industrial effluent stream is passed through a filter press, such as, a chamber filter press, plate filter press, frame filter press, membrane filter press, screw filter press and belt filter press or through a centrifuge, wherein the waste solids are concentrated into a primary sludge or filter cake and the filtered waste water from the press or centrifuge is further processed until it is fit for discharge or reuse.

A typical sewage treatment plant takes in raw sewage and produces solids and clarified water. Typically the raw sewage is treated in a primary sedimentation stage to form a primary sludge and supernatant, the supernatant is subjected to biological treatment and then a secondary sedimentation stage to form a secondary sludge and clarified liquor, which is often subjected to further treatment before discharge.

It is standard practice to dewater the sludge by mixing a dose of polymeric flocculant into that sludge at a dosing point, and then substantially immediately subjecting the sludge to the dewatering process and thereby forming a cake and a reject liquor. The dewatering process may be centrifugation or may be by processes such as filter pressing or belt pressing.

In many countries, for regulatory reasons, most sludge cake is going to landfill. For landfill, the cake must be drier than 40% and also the amount of sludge going into any landfill must not be greater than 8% (mixture ratio). Therefore, it is desirable (i) to increase the content of separated dry matter (OS), if possible, above about 40 wt.-%, i.e. to keep the sludge cake moisture below about 60 wt.-% using current processes.

In conventional or standard processes of dewatering aqueous sludge various ionic, anionic, and cationic polymers have been added to aqueous sludge as polymeric flocculants to induce flocculation formation of the solid materials in the sludge. Other methods have included adding quick lime (CaO) to the aqueous sludge in order to increase dry matter contents (OS). However, the addition of quick lime is expensive and laborious. Therefore, there is a demand for simple processes for dewatering sludge which achieves high solids contents. In particular, it is an objective to increase the residual dry matter in the filter cake of dewatered sludge and to decrease the moisture content in the filter cake, respectively.

Therefore, it was an objective to provide copolymer compositions that show improved performance as a dewatering aid for sludge dewatering in waste water and sewage treatment.

The currently produced composition uses a cationic polyacrylamide terpolymer that provides for improved efficacy in dewatering aqueous sludge. Although not wanting to be bound by theory, it is believed the second nonionic monomer, exhibits a vinyl polymerizable group attached directly to the polymer backbone. This provides for a lesser steric hindered monomer which can rotate and is more flexible and enables the polymer to have a different conformation than conventional or standard CPAM polymers.

### BRIEF SUMMARY

The current disclosure relates to a method of dewatering aqueous sludge. The method involves treating or adding to an aqueous sludge a cationic polyacrylamide polymer comprising the reaction product of acrylyl monomer(s) comprising a nonionic amide; cationic monomer(s); and nonionic vinyl monomer(s). The treated aqueous sludge is then dewatered.

Also disclosed is a method of dewatering an aqueous sludge and increasing cake dryness in a sludge dewatering processes. The method includes treating or adding to an aqueous sludge a cationic polyacrylamide polymer that includes the reaction product of acrylic monomer(s) comprising a nonionic amide; cationic monomer(s); and nonionic vinyl monomer(s). The treated aqueous sludge is then dewatered producing a filter cake, which can be disposed of accordingly.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

The aqueous sludge to be dewatered by the process according to the invention is not particularly limited. The aqueous sludge as a starting material comes from, for example, mining sludge, municipal sludge, paper sludge and industrial sludge. It may be digested sludge, activated sludge, coarse sludge, raw sludge, and the like, and mixtures thereof.

Provided is a cationic polyacrylamide (cPAM) polymer comprising the reaction product of: acrylyl or acrylic monomer(s) comprising a nonionic amide; cationic monomer(s); and vinyl monomer(s).

In some aspects of the polymer, the acrylyl monomer(s) can be chosen from radically polymerizable cationic monomers selected from the group of trimethylammonium-C₂-C₆-alkyl(meth)acrylate halides, trimethylammonium-C₂-C₆-alkyl(meth)acrylamide halides, (meth)acrylamide, or combinations thereof.

In yet other aspects of the polymer, the acrylyl monomer(s) can be chosen from [(acryloyloxy)alkyl]trialkyls, (acrylamidoalkyl)trialkyls, or ammonium halides, such as [2-(acryloyloxy)ethyl]trimethyl ammonium chloride (AETAC), acryloyloxyethyltrimethyl ammonium chloride), 3-acrylamidopropyl)trimethyl ammonium chloride (APTAC, DiMAPA-Q) and combinations thereof.

In some aspects of the polymer, the vinyl monomer(s) can be chosen from vinyl formamide, vinyl acetate, vinyl alcohol, vinylpyrrolidone, and combinations thereof.

In yet other aspects of the polymer, the vinyl monomer(s) is vinyl formamide.

In some aspects of the polymer, the vinyl monomer(s) is present in an amount of from about 0.2 wt. % to about 20 wt. %, or 0.3 wt. % to about 15 wt. %, or 0.5 wt. % to about 10 wt. % based on the total weight of the cationic polyacrylamide polymer.

In some aspects of the polymer, the ratio of the acrylyl monomer(s); cationic monomer(s); and vinyl monomer(s) are present in a weight ratio of from about 49.9:50:0.1 to about 1:90:9 of the cationic polyacrylamide polymer.

In other aspects of the polymer, the overall charge density can be from about 50 wt. % to about 100 wt. %, or 60 wt. % to 75 wt. %.

Also provided is a method of dewatering an aqueous sludge that includes adding to the aqueous sludge a cationic polyacrylamide polymer comprising the reaction product of: acrylyl or acrylic monomer(s) comprising a nonionic amide; cationic monomer(s); and vinyl monomer(s) comprising a second nonionic group different from the nonionic amide group(s); and dewatering the treated aqueous sludge.

In some aspects of the method, the acrylyl monomer(s) can be chosen from radically polymerizable cationic monomers selected from trimethylammonium-C₂-C₆-alkyl(meth)acrylate halides, trimethylammonium-C₂-C₆-alkyl(meth)acrylamide halides, (meth)acrylamide, or combinations thereof.

In other aspects of the method, the acrylyl monomer(s) is chosen from [(acryloyloxy)alkyl]trialkyls, (acrylamidoalkyl)trialkyls, and/or ammonium halides.

In yet other aspects of the method, the acrylyl monomer(s) is chosen from [2-(acryloyloxy)ethyl]trimethyl ammonium chloride (AETAC), acryloyloxyethyltrimethyl ammonium chloride), 3-acrylamidopropyl)trimethyl ammonium chloride (APTAC, DiMAPA-Q), or combinations thereof.

In some aspects of the method, the vinyl monomer(s) is chosen from vinyl formamide, vinyl acetate, vinyl alcohol, vinylpyrrolidone, and combinations thereof.

In yet other aspects of the method, the vinyl monomer(s) is vinyl formamide.

In some aspects of the method, the cationic polyacrylamide polymer is added to the aqueous sludge in an amount of from about 5 kilogram (kg) actives/ton (t) dry sludge to about 20 kg actives/t dry sludge or about 8 kg actives/t dry sludge to about 15 kg actives/t dry sludge based on the weight of the aqueous sludge.

In some aspects of the method, dewatering is conducted through a centrifugation process.

In other aspects of the method, the step of dewatering is conducted in a chamber filter press, a plate filter press, a frame filter press, a membrane filter press, a screw filter press, and/or a belt filter press.

In some aspects of the method, the aqueous sludge is derived from municipal, industrial, paper waste water or mining processes.

In yet other aspects of the method, a filter cake is produced from the dewatered sludge in which the filter cake solids from the treated aqueous sludge is increased by at least 10% when compared with filter cake solids of aqueous sludge treated with conventional polymers under the same conditions.

### EXAMPLES

### Preparation of Comparative Composition

An aqueous phase was prepared by adding 276 g acrylamide (50 wt %), 0.6 g Trilon C, 394 g ADAME Quat (80 wt %), 90 g water and 2 ppm N,N′-methylene bis acrylamide to a 2-liter (L) beaker. While stirring, the pH was adjusted to a pH of 3 using sulphuric acid. In a second 2-L beaker, an organic phase was prepared by mixing 20 g Zephrym 7053, 3 g Degacryl 3059 L, 12.7 g Intrasol FA1218/5 and 247 g paraffin oil. See Table 1.

The aqueous phase was then charged to the oil phase under vigorous stirring followed by mixing with a homogenizer to obtain a stable water-in-oil inverse emulsion. The inverse emulsion was added to a 2 L glass reaction vessel equipped with an anchor stirrer, thermometer and a distillation device and the emulsion was evacuated. The temperature of the emulsion was adjusted to 63±1° C. and after 30 minutes of air stripping or distillation to remove any volatile organic compounds (VOCs), the polymerization was initiated by an initial charge of a 1 wt. % V-65 in oil based on total weight of the emulsion. The amount of distillate under negative pressure was 110 milliliters (ml). After the distillation, the vacuum was removed. The residual monomers react adiabatically typically reaching a maximum temperature of about 70° C. The emulsion was stirred for an additional 15 minutes, and vacuum was again applied until the vessel cooled to 40° C. The vacuum was discontinued and two grams (g) of sodium peroxodisulfate (25 wt. %) and eleven grams sodium bisulfite (25 wt. %) were added to the vessel to reduce the monomer content. Finally, an activator was added to the vessel under stirring to the final product to invert the inverse emulsion more easily in water. If the inverse emulsion is given to water the polymer is dissolved in the water after inversion.

### Preparation of New Composition

The new composition was prepared as with the standard composition, except that vinyl formamide was added as third monomer to the water phase—237 g acrylamide (50 wt %), 394 g ADAME Quat (80 wt %), 19 g vinyl formamide (100 wt %) and 0 ppm N,N′-methylene.

TABLE 1
Formulations

| First Beaker - Standard Composition | First Beaker - New Composition |
|---|---|
| ADAME Quat (acryloyl oxyethyl | ADAME Quat (acryloyl oxyethyl |
| trimethylammonium chloride) | trimethylammonium chloride) |
| Trilon C - chelator | Trilon C - chelator |
| N,N′-methylene bis acrylamide | |
| Second Beaker - Standard Composition | Second Beaker - New Composition |
| Zephrym 7053 - hydrophobic emulsifier | Zephrym 7053 - hydrophobic emulsifier |
| Degacryl 3059 L - shear stabilizer | Degacryl 3059 L - shear stabilizer |
| Intrasol FA1218/5 - hydrophilic emulsifier | Intrasol FA1218/5 - hydrophilic emulsifier |
| (alcohols, C12-18, ethoxylated > 1 < 2.5 mole) | (alcohols, C₁₂₋₁₈, ethoxylated > 1< 2.5 mole) |
| Paraffin oil | Paraffin oil |

Samples of aqueous sludge were obtained from a waste water facility located in Koln, Germany. Two 500 milliliter (ml) samples of sludge were treated with two different dosages of a standard drainage aid that were used as a benchmark in the study. The sludge was treated with two different dosage levels as indicated in Tables 2. The samples were sheared at 1000 rpm with a four-fingered stirrer for 10-20 seconds, to simulate the centrifuges used in the dewatering facility. The aqueous sludge was dewatered using a 315 micron (μm) metallic sieve. The dewatering time of 300 ml filtrate was measured, and the clarity of the filtrate determined using a graduated measuring wedge.

A plexiglass disc was used to cover the filter cake that remained in the sieve and a 10 kilogram (kg) weight was placed on top of the plexiglass disc for 1 minute at which time cake compactness was evaluated by visual inspection to determine if the filter cakes press ability was good, fair, or bad. Second, a part of the pressed filter cake (weighted) was placed in a heating oven at 105° C. overnight. The dried filter cake was weighed back and the total solids (TS) of the cake was noted.

### Dewatering Time and Clarity

TABLE 2
KA Köln-Langel

| | 180 ppm = 7.2 kg/t | | | 210 ppm = 8.4 kg/t | | |
|---|---|---|---|---|---|---|
| | Dewatering | | TS cake | Dewatering | | TS cake |
| | time [s] | Clarity | solid [%] | time [s] | Clarity | solid [%] |
| New | 29 | 13 | 8.9 | 8 | 18 | 9.5 |
| Composition 1 | | | | | | |
| New | 64 | 10 | 7.9 | 21 | 16 | 9.0 |
| Composition 2 | | | | | | |
| Standard | 213 | 3 | 6.8 | 50 | 6 | 7.8 |
| Composition | | | | | | |

Dewatering (time for 300 ml filtrate): lower is better.
Clarity (filtrate in turbidity wedge): higher is better.
TS cake solid (105° C., overnight): higher is better.

As can be seen from Table 2, the terpolymer composition comprising both the acrylyl and vinyl monomers had improved efficacy over a standard formulation. Table 2 also indicates that there are only selective combinations that will provide the desired results.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A cationic polyacrylamide polymer comprising the reaction product of: acrylyl monomer(s) comprising a nonionic amide; cationic monomer(s); and nonionic vinyl monomer(s).

2. The polyacrylamide polymer according to claim 1, wherein the acrylyl monomer(s) can be chosen from radically polymerizable cationic monomer which is selected from the group of trimethylammonium-C₂-C₆-alkyl(meth)acrylate halides, trimethylammonium-C₂-C₆-alkyl(meth)acrylamide halides, (meth)acrylamide, or combinations thereof.

3. The polymer according to claim 1, wherein the acrylyl monomer(s) can be chosen from [acryloyloxy)alkyl]trialkyls, (acrylamidoalkyl)trialkyls, or ammonium halides.

4. The polymer according to any one of claim 1, wherein the acrylyl monomer(s) can be chosen from [2-(acryloyloxy)ethyl]trimethyl ammonium chloride (AETAC), acryloyloxyethyltrimethyl ammonium chloride), 3-acrylamidopropyl)trimethyl ammonium chloride (APTAC, DiMAPA-Q) and combinations thereof.

5. The polymer according to any one of claim 1, wherein the vinyl monomer(s) can be chosen from vinyl formamide, vinyl acetate, vinyl alcohol, vinylpyrrolidone, and combinations thereof.

6. The polymer according to claim 5, wherein the vinyl monomer(s) is vinyl formamide.

7. The polymer according to any one of claim 1, wherein the vinyl monomer(s) is present in an amount of from about 0.2 wt. % to about 20 wt. %, or 0.3 wt. % to about 15 wt. %, or 0.5 wt. % to about 10 wt. % based on the total weight of the cationic polyacrylamide polymer.

8. The polymer according to any one of claim 1, wherein the ratio of the acrylyl monomer(s); cationic monomer(s); and vinyl monomer(s) are present in a weight ratio of from about 49.9:50:0.1 to about 1:90:9 of the cationic polyacrylamide polymer.

9. The polymer according to any one of claim 1, wherein the cationic polyacrylamide polymer has an overall charge density of from about 50 wt. % to about 100 wt. %.

10. A method of dewatering an aqueous sludge comprising:
a) adding to the aqueous sludge a cationic polyacrylamide polymer comprising the reaction product of: acrylyl monomer(s) comprising a nonionic amide; cationic monomer(s); and nonionic vinyl monomer(s); and
b) dewatering the aqueous sludge obtained from step a).

11. The polyacrylamide polymer according to claim 10, wherein the acrylyl monomer(s) can be chosen from radically polymerizable cationic monomer which is selected from the group of trimethylammonium-C₂-C₆-alkyl(meth)acrylate halides, trimethylammonium-C₂-C₆-alkyl(meth)acrylamide halides, (meth)acrylamide, or combinations thereof.

12. The method according to claim 11, wherein the acrylyl monomer(s) can be chosen from [2-(acryloyloxy)ethyl]trimethyl ammonium chloride (AETAC), acryloyloxyethyltrimethyl ammonium chloride), 3-acrylamidopropyl)trimethyl ammonium chloride (APTAC, DiMAPA-Q) and combinations thereof.

13. The method according to any one of claim 10, wherein the vinyl monomer(s) can be chosen from vinyl formamide, vinyl acetate, vinyl alcohol, vinylpyrrolidone, and combinations thereof.

14. The method according to claim 13, wherein the vinyl monomer(s) is vinyl formamide.

15. The method according to any one of claim 10, wherein the cationic polyacrylamide polymer is added to the aqueous sludge in an amount of from about 5 kilogram actives/ton dry sludge to about 20 kilogram actives/ton dry sludge or about 8 kilogram actives/ton dry sludge to about 15 kilogram actives/ton dry sludge based on the weight of the aqueous sludge.

16. The method according to any one of claim 10, wherein dewatering is conducted through a centrifugation process.

17. The method according to any one of claim 10, wherein the step of dewatering is conducted in a chamber filter press, a plate filter press, a frame filter press, a membrane filter press, a screw filter press and/or a belt filter press.

18. The method according to any one of claim 10, wherein the aqueous sludge is derived from municipal, industrial, paper waste water or mining processes.

19. The method according to any one of claim 10, wherein a filter cake is produced from the dewatered sludge.

20. The method according to any one of claim 19, wherein the filter cake solids from the treated aqueous sludge is increased by at least 10% when compared with filter cake solids of aqueous sludge treated with conventional polymers under the same conditions.
